(19) United States
(12) Patent Application Publication
(10) Pub. No.: US 2025/0297927 A1
(43) Pub. Date: Sep. 25, 2025

(54) SALT SAMPLING SYSTEM AND APPARATUS

(71) Applicant: ABILENE CHRISTIAN UNIVERSITY, Abilene, TX (US)

(72) Inventors: Sean Rolan, Abilene, TX (US); Walter Philips, Abilene, TX (US); John Stai, Abilene, TX (US); Thomas Lyons, Abilene, TX (US); Charles Danysh, Abilene, TX (US); Elhadji Barry, Abilene, TX (US)

(21) Appl. No.: 19/064,109

(22) Filed: Feb. 26, 2025

Related U.S. Application Data
(60) Provisional application No. 63/569,578, filed on Mar. 25, 2024.

(51) Int. Cl. G01N 1/14

(52) U.S. Cl. CPC G01N 1/1409; G01N 2001/1454

(57) ABSTRACT

A salt sampling apparatus includes a containment cell and plunger. The containment cell defines a cell volume, an upper cell mating feature and a lower cell mating feature within the cell volume, and a through-bore extending completely through the containment cell. The plunger is arrangeable within the cell volume along the through-bore and defines a shaft portion, and an upper plunger mating feature and a lower plunger mating feature. The lower plunger mating feature defines a well about the shaft portion configured to receive a volume of a molten salt material. The plunger is moveable between a first position in which the well is positioned substantially out of the cell volume, and a second position in which the well is positioned substantially in the cell volume with the well sealed within the containment volume by the engagement of the containment cell and the plunger.

### RELATED APPLICATION

The present application relates and claims priority to U.S. Provisional Application No. 63/569,578, filed on Mar. 25, 2024, which is hereby incorporated by reference in its entirety.

### TECHNICAL FIELD

The described examples relate generally to systems, devices, and techniques for process fluid sampling, such as those used in high temperature, corrosive, and/or nuclear environments.

### BACKGROUND

Systems that include high temperature, corrosive, or nuclear process fluid may have reason to monitor the process fluid. For example, operators of molten salt reactors may need to monitor the composition, among other information, of the fuel salt within the molten salt reactor. Retrieving the fuel salt from a molten salt reactor system may be difficult due to radiation of the salt, high temperatures and pressures associated with the reactor process, and requirement to maintain an inert environment about the fuel salt, among other considerations. Conventional approaches to salt sampling may fail to maintain an inert environment or hermetic seal about the salt sample, and may therefore be susceptible to undesirable reactions within the molten fuel salt when collecting the sample. As such, there remains a need for improved salt sampling and collection systems that can effectively capture a sample of molten salt, maintain a sealed environment thereabout, and manipulate the salt sample for extraction by personnel for subsequent analysis of the salt sample.

### SUMMARY

In one example, a salt sampling system is disclosed. The salt sampling system includes a sampling shaft, an isolation tunnel, and an extraction shaft. The sampling shaft, the isolation tunnel and the extraction shaft are fluidly coupled to one another in series and isolatable from one another using a pair of isolation valves interposed therebetween. The salt sampling system further includes a transfer system arranged in the isolation tunnel and configured to move a salt sampling apparatus from the sampling shaft to an extraction position of the isolation tunnel. The salt sampling system further includes an extraction system operatively engaged with the extraction shaft and configured to move the salt sampling apparatus from the extraction position to the extraction shaft.

In another example, the transfer system may include a sample pulley having a cable removably attached to the salt sampling apparatus. The sample pulley may be operable to move the salt sampling apparatus along and out of the sampling shaft. The transfer system may further include a lateral rail in the isolation tunnel. The lateral rail may be coupled to the sample pulley and configured to move the sample pulley and salt sampling apparatus attached thereto laterally along the isolation tunnel. The transfer system may further include a conveyor in the isolation tunnel opposite the lateral rail. The conveyor may be configured to receive the salt sampling apparatus and convey the salt sampling apparatus along the isolation tunnel to the extraction position. The salt sampling apparatus may be removably couplable from the cable.

In another example, the extraction system may include an extraction pulley having a cable removably attachable to the salt sampling apparatus. The extraction pulley may be operable to move the salt sampling apparatus from the extraction position and into the extraction shaft.

In another example, the pair of isolation valves includes a first isolation valve arranged between the sampling shaft and the isolation tunnel, and a second isolation valve arranged between the isolation tunnel and the extraction shaft. The salt sampling system is operable to maintain isolation of the sampling shaft and the extraction shaft: (i) in a first configuration, with the first isolation valve open and the second isolation valve closed, thereby permitting the movement of the salt sampling apparatus from the sampling shaft, through the first isolation valve, and into the isolation tunnel, (ii) in a second configuration, with the first and second isolation valves closed, thereby permitting the movement of the salt sampling apparatus through the isolation tunnel and to the extraction position, (iii) in a third configuration, with the first isolation valve closed and the second isolation valve open, thereby permitting the movement of the salt sampling apparatus from the extraction position, through the second isolation valve, to the extraction shaft, and (iv) in a fourth configuration with the first and second isolation valves closed, thereby permitting movement of the salt sampling apparatus along and out of the extraction shaft.

In another example, the salt sampling apparatus may include a containment cell. The containment cell may define a cell volume. The containment cell may further define an upper cell mating feature and a lower cell mating feature within the cell volume. The containment cell may further define a through-bore extending completely through the containment cell and intersecting the cell volume. The salt sampling apparatus may further include a plunger arrangeable within the cell volume along the through-bore. The plunger may define a shaft portion. The plunger may further define an upper plunger mating feature and a lower plunger mating feature. Each of the upper plunger mating feature and the lower plunger mating feature may extend laterally from the shaft portion and may be axially off set from one another along the shaft portion. The lower plunger mating feature may define a well about the shaft portion configured to receive a volume of a molten salt material. The plunger may be moveable between: (i) a first position in which the well is positioned substantially out of the cell volume, and (ii) a second position in which the well is positioned substantially in the cell volume with the upper plunger feature and the lower plunger feature contacting a respective one of the upper cell mating feature and the lower cell mating features to seal a received volume of molten salt material within the cell volume.

In another example, a salt sampling apparatus is disclosed. The salt sampling apparatus includes a containment cell. The containment cell defines cell volume. The containment cell further defines an upper cell mating feature and a lower cell mating feature within the cell volume. The containment cell further defines a through-bore extending completely through the containment cell and intersecting the cell volume. The salt sampling apparatus further includes a plunger arrangeable within the cell volume along the through-bore. The plunger defines a shaft portion. The plunger further defines an upper plunger mating feature and a lower plunger mating feature. Each of the upper plunger mating feature and the lower plunger mating feature extend laterally from the shaft portion and are axially off set from one another along the shaft portion. The lower plunger mating feature defines a well about the shaft portion that is configured to receive a volume of a molten salt material. The plunger is moveable between a first position in which the well is positioned substantially out of the cell volume, and a second position in which the well is positioned substantially in the cell volume with the upper plunger feature and the lower plunger feature contacting a respective one of the upper cell mating feature and the lower cell mating feature to seal a received volume of molten salt material within the cell volume.

In another example, in the second position, the received volume of molten salt may be hermetically sealed within the cell volume.

In another example, the through-bore may be defined along an axial direction of the containment cell. The upper cell mating feature and the lower cell mating feature may be defined about the through-bore. The upper plunger mating feature and the lower plunger mating feature may be defined about the shaft portion.

In another example, the plunger may be moveable between the first position and the second position along the axial direction.

In another example, in the second position, the upper cell mating feature and the upper plunger mating feature may cooperate to form an upper hermetic seal of the cell volume fully about the shaft portion. The lower cell mating feature and the lower plunger mating feature may cooperate to form a lower hermetic seal of the cell volume fully about the shaft portion.

In another example, the lower plunger mating feature may define a lower plunger mating surface that extends angularly relative to the shaft portion. The lower cell mating feature may define a lower cell mating surface that is complementary to the lower plunger mating surface.

In another example, the containment cell stops relative axial movement of the plunger at the second position by: (i) an engagement of the upper cell mating feature and the upper plunger mating feature, and (ii) an engagement of the lower cell mating feature and the lower plunger mating feature.

In another example, the well may define a sample volume for the molten salt material fully about the shaft portion.

In another example, the containment cell includes a housing. The containment cell may further include a receptacle piece engaged with the housing. The receptacle piece and the housing may cooperate to define the cell volume and the through-bore extending therethrough. The containment cell may further include a pair of slidable brackets engaged with a top surface of the housing on opposing sides of the through-portion. In this regard, the pair of slidable brackets may slide between (i) an open position in which the through-bore is substantially unobstructed by the pair of brackets, and (ii) a locking position in which the through-bore is at least partially obstructed by the pair of brackets.

In another example, the housing and/or receptacle piece may define a pair of lower piston engagement features configured to receive a corresponding pair of lower pistons for locking the containment cell axially. Further, the pair of slidable brackets may define a respective pair of upper piston engagement features configured to receive a corresponding pair of upper pistons for sliding the brackets between the open position and the closed locking position while the containment cell is locked axially.

In another example, the plunger may include an attachment mechanism extending from the shaft portion opposite the lower plunger mating feature. The attachment mechanism may be configured to couple the plunger to a cable of a pulley.

In another example, a method of salt sampling is disclosed. The method includes providing a salt sampling apparatus, such as any of the salt sampling apparatuses described herein. The method further includes lowering the salt sampling apparatus into a sampling shaft. The method further includes engaging the containment cell on a lip within the sampling shaft. The method further includes lowering the plunger deeper into the sampling shaft to the first position while the containment cell rests on the lip. The method further includes capturing molten salt material in the well.

In another example, the method may further include raising the plunger in the sampling shaft from the first position to the second position.

In another example, the method may further include creating a hermetic seal between the upper cell mating feature and the upper plunger mating feature and the lower cell mating feature and the lower plunger mating feature by: (i) locking the containment cell axially along the sampling shaft using one or more pistons, and (ii) inducing a force on the plunger that biases and compresses the plunger toward the containment cell.

In another example, the one or more pistons comprises a pair of lower pistons. In this regard, the method may further include operating a pair of upper pistons to slide a corresponding pair of slidable brackets of the containment cell toward the plunger to stabilize a lateral position of the plunger within the containment cell. The method may further include releasing the pair of lower pistons and the pair of upper pistons from the containment cell. The method may further include moving salt sampling apparatus out of the sampling shaft for retrieval of the molten salt collected therein.

In addition to the example aspects described above, further aspects and examples will become apparent by reference to the drawings and by study of the following description.

### BRIEF DESCRIPTION OF THE DRAWINGS

FIG. 1 depicts an example salt sampling system.

FIG. 2 depicts an example molten salt reactor system.

FIG. 3A depicts an isometric view of an example plunger of a salt sampling apparatus of the present disclosure.

FIG. 3B depicts a cross-sectional view of the example plunger of FIG. 3A, taken along line 3B-3B of FIG. 3A.

FIG. 4A depicts an isometric view of an example containment cell of a salt sampling apparatus of the present disclosure.

FIG. 4B depicts a cross-sectional view of the example containment cell of FIG. 4A, taken along line 4B-4B of FIG. 4A.

FIG. 5A depicts an isometric view of an example salt sampling apparatus including the example plunger of FIG. 3A and the example containment cell of FIG. 4A.

FIG. 5B depicts a cross-sectional view of the example salt sampling apparatus of FIG. 5A, taken along line 5B-5B of FIG. 5A.

FIG. 6 depicts the salt sampling apparatus of FIG. 5A in a first configuration.

FIG. 7 depicts the salt sampling apparatus of FIG. 5A in a second configuration.

FIG. 8 depicts the salt sampling apparatus of FIG. 5A in a third configuration.

FIG. 9 depicts the salt sampling apparatus of FIG. 5A in a fourth configuration.

FIG. 10 depicts the salt sampling apparatus of FIG. 5A in a fifth configuration.

FIG. 11 depicts the salt sampling apparatus of FIG. 5A in a sixth configuration.

FIG. 12 depicts the salt sampling apparatus of FIG. 5A in a seventh configuration.

FIG. 13 depicts the salt sampling apparatus of FIG. 5A in an eighth configuration.

FIG. 14A depicts an example sampling shaft of the present disclosure.

FIG. 14B depicts another example sampling shaft of the present disclosure.

FIG. 15 depicts an example salt sampling system of the present disclosure in a first configuration.

FIG. 16 depicts the example salt sampling system of FIG. 15 in a second configuration.

FIG. 17 depicts the example salt sampling system of FIG. 15 in a third configuration.

FIG. 18 depicts a flow diagram of an example method of salt sampling.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a salt sampling apparatus, system, and methods of use thereof. A salt sampling apparatus or system, as described herein, may be used to collect samples of molten salt from a molten salt reactor (“MSR”) system. MSRs offer an approach to power that can utilize molten salts as their nuclear fuel in place of the conventional solid fuels used in light water reactors. Advantages include efficient fuel utilization and enhanced safety (in part due to replacing water as a coolant with molten salt). In some MSRs, fission reactions can occur within a molten salt composition housed with a reactor vessel. In certain conventional MSRs, fuel salt undergoes a fission reaction in a reactor vessel. Such conventional MSRs may operate by pumping the fuel salt from the reactor vessel along a “loop,” first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections, which may each present the possibility for leaks or other failure mechanisms. It may be desirable to obtain a sample of the molten salt of the MSR from time to time, for example, in order to determine the contents of the molten salt and other system parameters. Retrieving the fuel salt from the MSR may be difficult due to radiation of the salt, high temperatures and pressures associated with the reactor process, and requirement to maintain an inert environment about the fuel salt, among other considerations. Conventional approaches to salt sampling may fail to maintain an inert environment or hermetic seal about the salt sample, and may therefore be susceptible to undesirable reactions within the molten fuel salt when collecting the sample.

To mitigate these and other challenges, disclosed herein is a salt sampling apparatus that is configured to collect a molten salt sample, maintain a hermetic seal about the molten salt sample, and manipulate or move the molten salt sample away from the MSR such that the sample can be access by personnel for subsequent chemical analysis. To facilitate the foregoing, the salt sampling apparatus may include a containment cell and a plunger disposed therein that cooperate to capture the molten salt and maintain the hermetic seal thereabout. For example, the containment cell may define a cell volume therein and include an upper cell mating feature and the a lower cell mating feature in the cell volume. The containment cell may further include a through-bore extending through the containment cell and cell volume. The plunger may be disposed generally within the through-bore and configured to collect the molten salt sample therein and seal the sample within the cell volume. For example, the plunger may include a plunger portion and an upper plunger mating feature and a lower plunger mating feature, each extending from the plunger portion. The lower plunger portion may further include a well to collect the salt sample. In operation, the plunger may exit the through-bore and dip into a stream of molten salt of the MSR such that well fills with the molten salt. The plunger may be subsequently caused to return to the through-bore within the cell volume such that the upper cell mating feature and the lower cell mating feature engage with respective ones of the upper plunger mating feature and the lower plunger mating feature. Upon such engagement, the molten salt sample may be hermetically sealed within the containment cell and bounded by the respective engagement of the upper cell mating feature/upper plunger mating feature and the lower cell mating feature/lower plunger mating feature.

The salt sampling apparatus may be operable to collect the molten salt sample within one or more salt sampling systems, as described herein. In one example, a salt sampling system may cause the salt sampling apparatus to be lowered into a salt sampling shaft. In the sampling shaft, the salt sampling apparatus may engage and rest on a lip within the sampling shaft. The lip of the sampling shaft may prevent movement of the containment cell deeper in the sampling shaft. Notwithstanding, the plunger of the apparatus may continue to move deeper in the sampling shaft and dip into and retrieve a quantity of molten salt, as described herein. On return of the plunger to the containment cell, as described in greater detail below, the containment cell may be temporarily locked in place within the sampling shaft by one or more pistons. Accordingly, the plunger, including the salt sample therein, may be forced against the containment cell (e.g., forced against the upper cell mating feature and the lower cell mating feature) in order to form a hermetic seal about the sample within the cell volume. Further, one or more pistons may be activated in order to lock or stabilize the piston in place within the through-bore in order to facilitate the creation and/or maintenance of the hermetic seal. Subsequently, the sampling system may cause the sampling apparatus to move from the sampling shaft and to a lateral transfer system. The lateral transfer system may move the salt sampling apparatus (including the hermetically sealed sample therein) laterally away from the sampling shaft and toward an extraction system. The extraction system may permit the physical removal of the sampling apparatus from the sampling system for chemical analysis of the sample by personnel. In some cases, multiple isolation valves may be interposed throughout the sampling shaft, transfer system, and extraction system in order to fluidically isolate the molten salt stream of the MSR from the extraction point of the sampling apparatus.

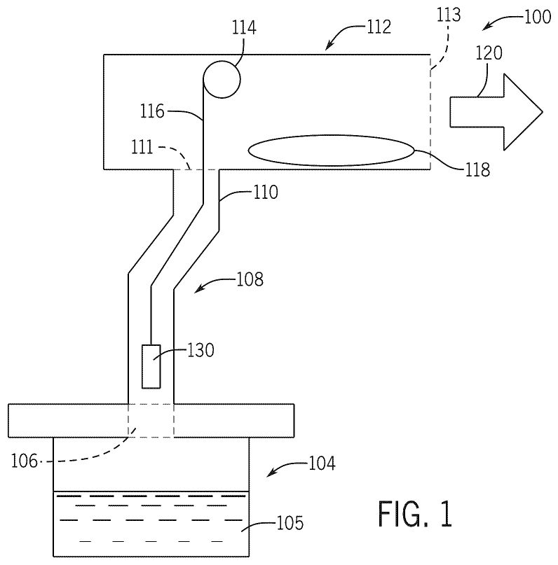

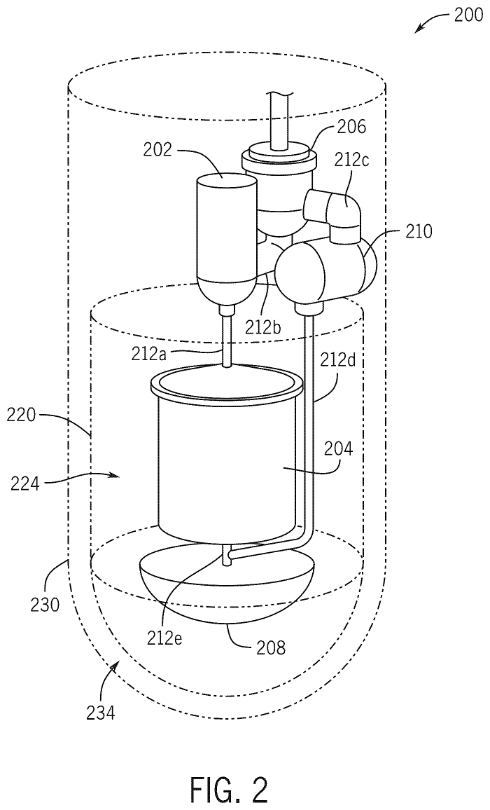

Turning to the Drawings, FIG. 1 depicts a schematic view of an example salt sampling system 100. The system 100 illustrates, schematically, the salt sampling apparatus and system described generally above. For example, FIG. 1 shows the system 100 as include a molten salt system 104 (such as the molten salt system 200 described in greater detail below with reference to FIG. 2). The molten salt system 104 may be a portion of a MSR, such as a pipe run, or other access point includes a molten salt material 105. The molten salt system 104 may include an access port 106. The access port 106 may permit removable entry for one or more sample collection apparatus or devices to retrieve the molten salt material 105. In this regard, the system 100 is shown in FIG. 1 as further including a sample shaft 108 extending from the access port 106 and an extraction system 112 extending from the sample shaft 108. The sample shaft 108 may define a circuitous path 110 between the extraction system 112 and the access port 106 through which a salt sampling apparatus 130 may travel. In some cases, one or more isolation valves may be positioned along the circuitous path 110 in order to selectively isolate the access port 106 from the extraction system 112. The sample shaft 108 may have the circuitous path 110, for example, in order to traverse physical obstructions that are present in the reactor system, including other piping, vessels, and so forth. Accordingly, and as described in greater detail below, the sampling apparatus 130 is configured to traverse the circuitous path 110 and retrieve the salt therein.

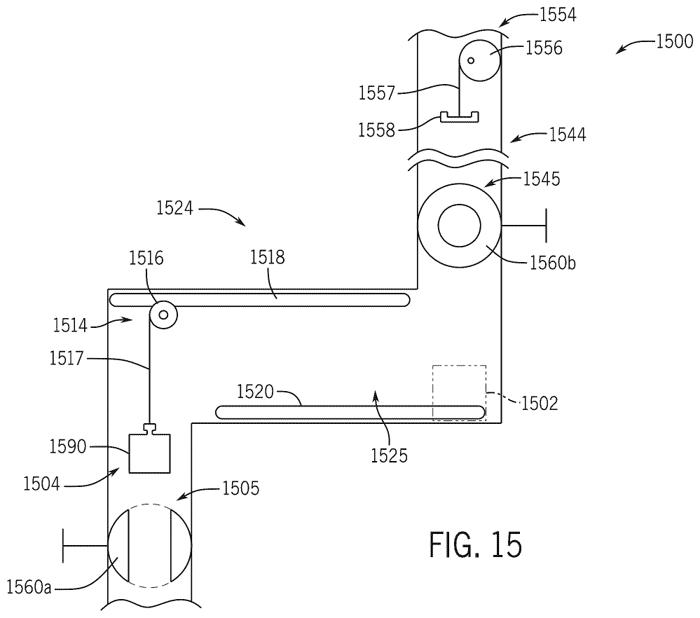

FIG. 1 further shows the system 100 as having the extraction system 112 as defining a first threshold 111 and a second threshold 113. The first threshold 111 and the second threshold 113 may represent isolation points in the system 100, for example, whereat an extraction direction 120 can be fluidically isolated from the sample shaft 108 and/or from an exterior environment for sample removal. The extraction system 112 may include one or more components to facilitate the physical movement of the sampling apparatus 130. For example, the extraction system 112 may include a pulley 114 and a cable 116. The cable 116 may permit the removable attachment of the salt sampling apparatus 130 to the pulley 114. The pulley 114 may operate to cause movement of the salt sampling apparatus 130 through the sample shaft 108 via rotation of the pulley 114 and corresponding movement of the cable 116. The system 100 may also include a conveyor system 118 within the extraction system 112 to facilitate lateral movement of the sampling apparatus 130. For example, the pulley 114 may operate to move the sampling apparatus 130 from the sample shaft 108, through the first threshold 111 and into the extraction system 112. Subsequently, the cable 116 may be released from the sampling apparatus, and the conveyor system 118 may cause the sampling apparatus 130 to move toward and through the second threshold 113 and along the extraction direction 120. The extraction direction 120 may be representative of a location whereat the salt sample may be removed from the system 100 for chemical analysis, as described herein greater detail with reference to FIGS. 15-17.

FIG. 2 depicts an example molten salt reactor system 200. The molten salt reactor system 200 is depicted and described herein to illustrate example molten salt reactor process that may be associated with the salt sampling apparatus and systems disclosed herein, such as the molten salt system 104 discussed generally above with reference to FIG. 1. For example, the various molten salt sampling apparatus and systems of present disclosure may be used to obtain a salt sample from one more components of the system 200. Accordingly, while the molten salt reactor system 200 is described herein, it will be appreciated that such salt sampling apparatuses and system may be implement with a variety of molten salt reactor systems and other systems to obtain samples of fluids processed therein.

With reference to the molten salt reactor system 200 of FIG. 1, the example molten salt reactor system 200 of FIG. 2 utilizes fuel salt enriched with uranium (e.g., high-assay low-enriched uranium) to create thermal power via nuclear fission reactions. In at least one example, the composition of the fuel salt may be LiF—BeF₂—UF₄, though other compositions of fuel salts may be utilized as fuel salts within the reactor system 200. The fuel salt within the system 200 is heated to high temperatures (such as 600° C. or greater) and melts as the system 200 is heated.

As shown in FIG. 2, the molten salt reactor system 200 includes a reactor vessel 204 where the nuclear reactions occur within the molten fuel salt, a fuel salt pump 206 that pumps the molten fuel salt to a heat exchanger 210, such that the molten fuel salt re-enters the reactor vessel after flowing through the heat exchanger 210, and piping in between each component (e.g., piping 212a, 212b, 212c, 212d, 212e). The molten salt reactor system 200 may also include additional components, such as, but not limited to, drain tank 208 and reactor access vessel 202. The drain tank 208 may be configured to store the fuel salt once the fuel salt is in the reactor system 200 but in a subcritical state, and also acts as storage for the fuel salt if power is lost in the system 200. The reactor access vessel 202 may be configured to allow for introduction of small pellets of uranium fluoride (UF₄) to the system 200 as necessary to bring the reactor to a critical state and compensate for depletion of fissile material. In several examples, the molten salt reactor system 200 may include an inert gas system and/or an equalization system (not shown in FIG. 2) to provide inert gas to a head space of the various salt-bearing components of the system 200 and to equalize pressures therebetween as needed for a given operation of the system 200.

FIG. 2 further shows the system 200 as including an internal vessel or shield 220 that defines a first thermally insulative region 224 about select components of the system 200. FIG. 2 further shows the system 200 as including a reactor enclosure 230. The reactor enclosure may be constructed from a thermally insulative metal (including certain stainless steels) that is capable of withstanding substantially high temperatures, such as temperature in excess of 600° C. The reactor enclosure 230 is shown, schematically, as encompassing the entirety of the internal shield 220 and any other salt-bearing components that are not otherwise included with the internal shield 220. For example, the reactor enclosure 230 may define a second thermally insulative region 234 that receives the internal shield 220 and all the salt-bearing components that are not held within the first thermally insulative region 224. The internal shield 220 and the reactor enclosure 230 may therefore each define a containment barrier about the salt-bearing components of the system 200. Further, the internal shield 220 and the reactor enclosure 230 may define a substantially high-radiation and high-temperature zone of the system 200.

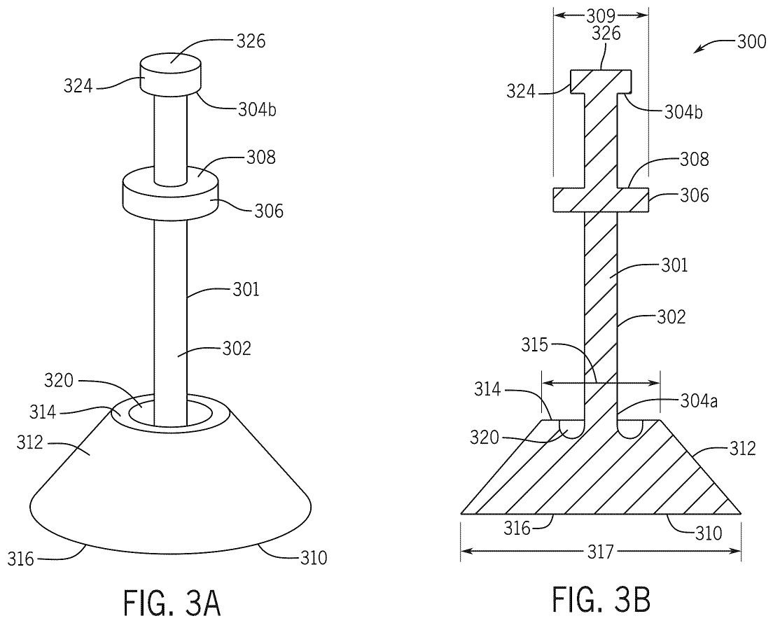

FIGS. 3A-5B depict various components of sampling apparatus described herein. With reference to FIGS. 3A and 3B, a plunger 300 of the sampling apparatus is shown. The plunger 300 may include a plunger body 301 that defines a shaft portion 302. The shaft portion 302 may have a first end 304a and a second end 304b disposed opposite the second end 304a. The plunger 300 is shown in FIGS. 3A and 3B as having an upper plunger mating feature 306 that defines an upper plunger mating surface 308 with a width 309. The plunger 300 is further shown as including a lower plunger mating feature 310 having an lower plunger mating surface 312. Each of the upper plunger mating feature 306 and the lower plunger mating feature 312 may extend laterally from the shaft portion 302. In one example, the upper plunger mating feature 306 may define an upper disc or stop feature revolved about an axis of the shaft portion 302. Further, the lower plunger mating feature 312 may define a cone shaped or angular feature also revolved about the axis of the shaft portion 302. In this regard, the plunger 300 is shown with the lower plunger mating feature 312 having a plunger cap 316 with a first width 317 and a plunger well surface 314, disposed opposite the plunger cap 316, with a second width 315 that is less than the first width 317. On the well surface 314, the plunger 300 may define a well 320. The well 320 may be configured to dip into and receive a volume of a molten salt material. The plunger 300 is further shown in FIGS. 3A and 3B with the second end 304a having an attachment mechanism 324 that defines a cable attachment surface 326. In operation, a cable or other structure may be attachable to the cable attachment structure 326 such that the plunger 300 is moveable axially into and out of a molten salt flow.

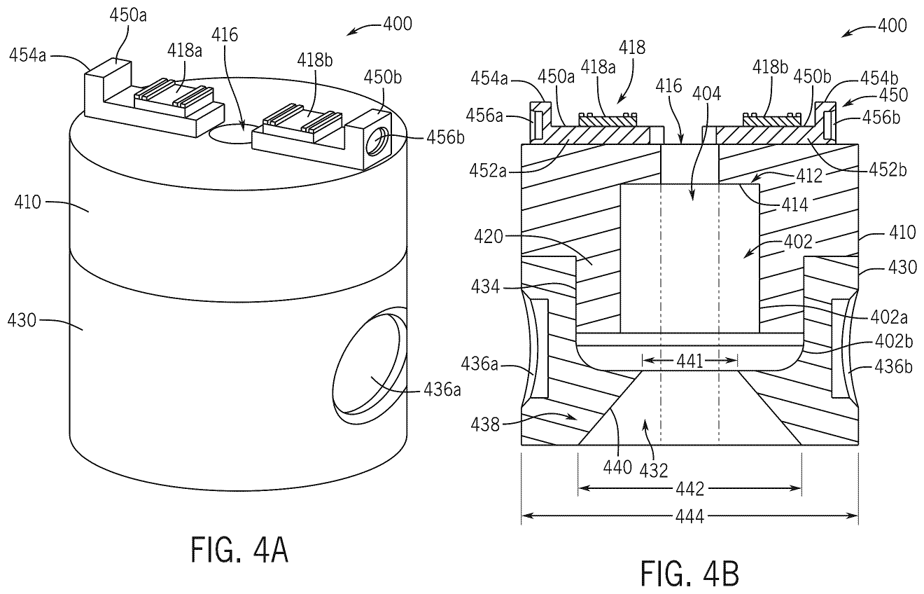

With reference to FIGS. 4A and 4B, an example containment cell 400 of the present disclosure is shown. As described herein, the containment cell 400 may be used with the plunger 300 to define the salt sampling apparatus. The containment cell 400 may be a structural component of the salt sampling apparatus that define a volume for capture of molten salt material. In this regard, the containment cell 400 may define a cell volume 402 having a first portion 402a and a second portion 402b. The containment cell 400 may further defining a through-bore 404 extending through a complete thickness of the containment cell 400 along an axial direction and intersecting the cell volume 402. While many configurations of the containment cell 400 are possible, the containment cell 400 is shown in FIGS. 4A and 4B as including a housing 410, a receptacle piece 430, and a pair of slidable brackets 450. The receptacle piece 430 and the housing 410 may cooperate to define the cell volume 402 and the through-bore 404 extending therethrough.

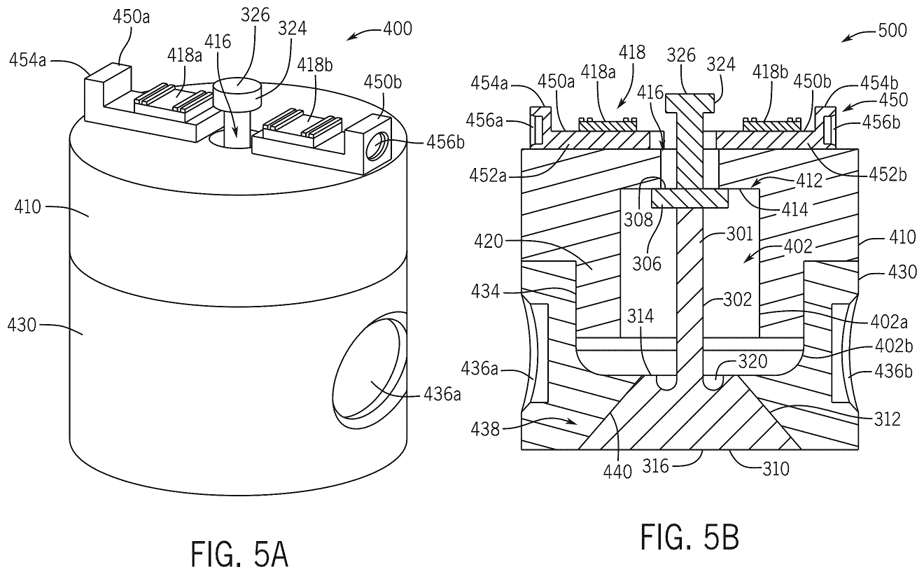

The housing 410 and the receptacle piece 430 may further collectively define various engagement features configured to engage with corresponding engagement features of the plunger 300 in order to form a hermetic seal therewith. For example, the housing 410 is shown as including an upper cell mating feature 412 having an upper cell mating surface 414. Further, the receptacle piece 430 is shown as including a lower cell mating feature 438 having a lower cell mating surface 440. As described in greater detail herein with reference to FIG. 5A and 5B, the upper cell mating feature 412 and the lower cell mating feature 438 may be adapted to contact respective plunger mating surfaces in order to prevent further upward movement of the plunger 300 within the cell volume 404. In order to further accommodate the plunger 300 within the cell volume 402, the housing 410 is further shown in FIG. 4B as defining a plunger shaft space 416. Additionally, the receptacle piece 430 is shown as defining a receiving space 432 and a seat 434. The seat 434 may be configured to receive and mate with a neck 420 of the housing 430 in order to define the structure of the containment cell 400. The receiving space 432 may be configured to fit a complementary piece of the plunger 300, and as such have a first width 441 at an interface with the cell volume 402, and a second width 442 opposite side interface. Further, the containment cell is shown in FIGS. 4A and 4B as having a third width 444, such as an outermost width, that is larger than the second width 442. As described herein, the third width 444 may be tailored to be larger than a width of a lip of sampling shaft of a sampling system such that the containment cell 400 can be caught on such lip and prevent from progressing toward the molten salt flow. On an exterior of the receptacle piece 430, lower piston engagement features 436a, 436b are defined. The lower piston engagement features 436a, 436b may be depressions or other features that receive pistons for temporarily locking the containment cell in place, for example, in the sampling shaft during sampling operations.

The containment cell 400 is further shown in FIGS. 4A and 4B as including the slidable brackets 450. A first slidable bracket 450a may include an elongated portion 452a and a tab portion 454a. The elongated portion 452a may be adapted for slidable engagement with a top surface of the housing 410 via a first bracket engagement piece 418a. The tab portion 454a may define an upper piston engagement feature 456a. The upper piston engagement feature 456a may be a depression or other feature that receives piston for purposes of causing a sliding the first slidable bracket 450a. As described herein, the first slidable bracket 450a may be slide in order to stabilize the plunger 300 within the cell volume 404 in order facilitate the maintenance of the hermetic seal established therein. The second slidable bracket 450b may be substantially analogous to the first slidable bracket 450a and may include an elongated portion 452b, a tab portion 456b, a piston engagement feature 456b and may be associated with a second bracket attachment piece 418b.

FIG. 5A depicts an isometric view of an example salt sampling apparatus 500 including the example plunger 300 of FIG. 3A and the example containment cell 400 of FIG. 4A. FIG. 5B depicts a cross-sectional view of the example salt sampling apparatus 500 of FIG. 5A, taken along line 5B-5B of FIG. 5A. As shown in FIG. 5B, the plunger 300 is adapted to fit into the containment cell 400 within the cell volume 402. The plunger 300 is adapted to fit into the containment cell 400 such that the upper plunger mating feature 306 contacts and engages the upper cell mating feature 412, and such that the lower plunger mating feature 310 contacts and engages the lower cell mating feature 438. Upon such contact and engagement, the well 320 may be positioned within and sealed within the cell volume 402.

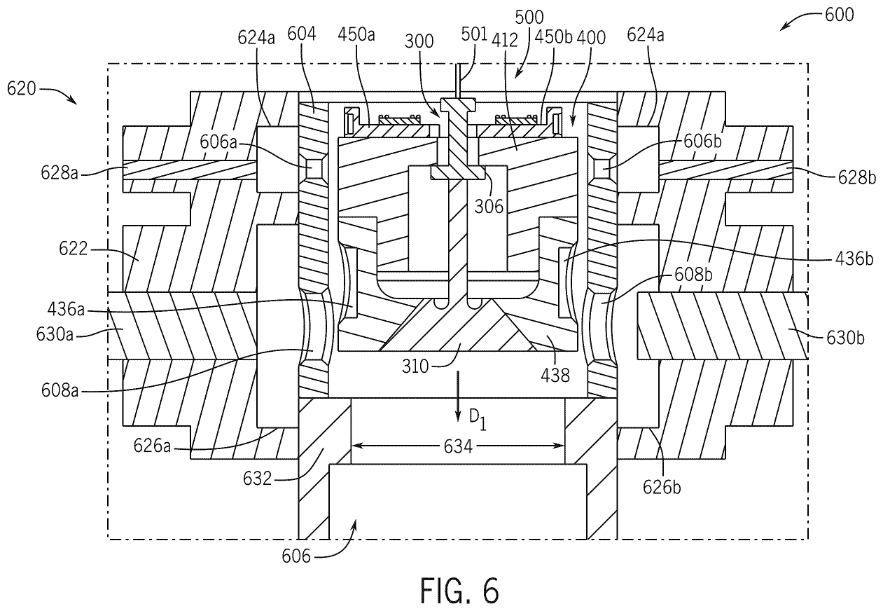

With reference to FIGS. 6-13, example operations of the salt sampling apparatus 500 are shown and described. With reference to FIG. 6, the salt sampling apparatus 500, including the containment cell 400 and the plunger 300, is shown in a first configuration 600 in which the salt sampling apparatus 500 is disposed with a sampling shaft 604. The sampling shaft 604 may be a pipe, conduit and/or other structure that fluidically couples and directs the salt sampling apparatus 500 toward a flow of molten salt material. In this regard, the sampling shaft 604 is shown as defining a shaft volume 606 through which some or a portion of the salt sampling apparatus 500 may pass through enroute to the molten salt material.

The sampling shaft 604 is depicted in FIG. 6 with numerous components that facilitate the operation of the salt sampling apparatus 500, including those which operate to temporarily lock the apparatus 500 in place, as needed for creation of the hermetic seal. For example, the sampling shaft 604 may define a sealing station 620 at which the salt sampling apparatus 500 may be permitted to create the hermetic seal about collected molten salt material, according the embodiments described herein. At the sealing station 620, the sampling shaft 604 may include a lip 632, which may define a reduced width 634 of the shaft volume 606. The reduced width 634 may be configured to prevent movement of at least the containment cell 400 deeper into the shaft volume 606, while optionally permitting the continued descent of the plunger 300 into the shaft volume 606. Further at the sealing station 620, the sampling shaft 604 may define upper piston ports 606a, 606b and lower piston ports 608a, 608b. The upper piston ports 606a, 606b may be holes or other through portions that permit entry of a corresponding pair of upper pistons therethrough for engagement with respective ones of the slidable brackets 450a, 450b. Further, the lower piston ports 608a, 608b may also be holes or other through portions that permit entry of a corresponding pair of lower pistons therethrough for engagement with respective ones of the lower piston engagement features 436a, 436b.

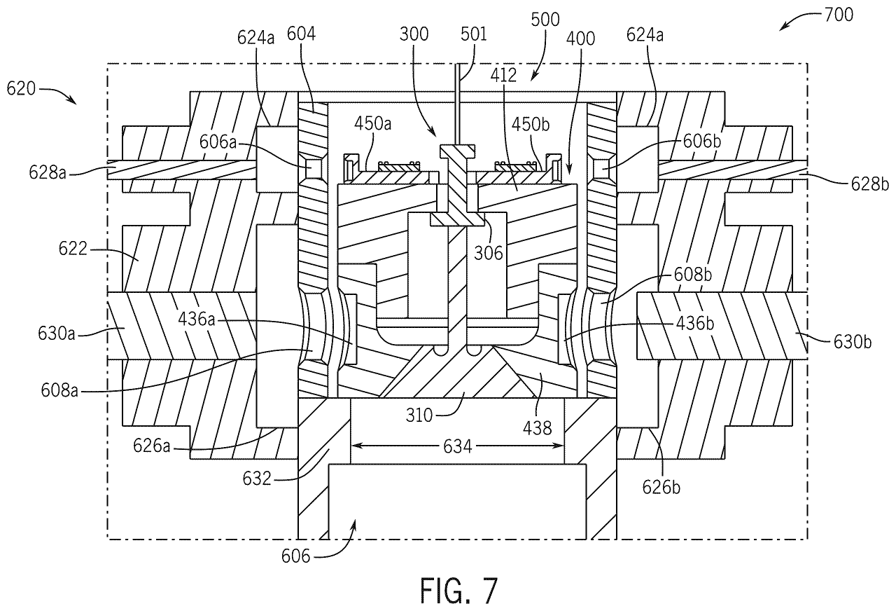

The sealing station 620 may further include one or pistons or piston assemblies configured to selectively engage and extend through the piston ports for engagement with the salt sampling assembly 500. For example, FIG. 6 shows the sealing station 620 as including a station structure 622. The station structure 622 may be a structural component of the sealing station 620 that wraps around the sampling shaft 604 and provides a structural housing for the one or more pistons of the sealing station 620. The station structure 622 may define various caps or interfaces about the piston ports, which may provide a sealed boundary about said piston port to facilitate the isolation of the port during entry and exit of the respective piston therein. For example, the station structure 622 may define upper piston caps 624a, 624b about respective ones of upper piston ports 606a, 606b. Further, the station structure 622 may define lower piston caps 626a, 262b about respective ones of lower piston ports 608a, 608b. The sealing station 620 may further include the one or more pistons described herein. For example, the sealing station 620 may include upper pistons 628a, 628b and lower pistons 630a, 630b. Broadly, and as described in greater detail herein with reference to FIGS. 7-13, the upper pistons 628a, 628b may be axially-driven pistons that, upon actuation, are configured to penetrate the sampling shaft 604 at respective ones of the upper piston ports 606a, 606b and engage with respective ones of the slidable brackets 450a, 450b. Further, the lower pistons 630a, 630b may be axially-driven pistons that, upon actuation, are configured to penetrate the sampling shaft 604 at respective ones of the lower piston ports 608a, 608b and engage with respective ones of the lower piston engagement features 436a, 436b.

In operation, FIG. 6 shows the salt sampling apparatus 500 being lowered in the sampling shaft 604 and toward the sealing station 620. For example, the salt sampling apparatus 500 may be lowered via a cable 501 that is removably attached to the plunger 300 at the attachment mechanism 324. In this regard the containment cell 410 may rest on, and be lowered and raised within the sampling shaft 604, via the movement of the plunger 300. As shown in FIG. 6, the upper cell mating feature 412 may rest on the upper plunger mating feature 306. Further, the lower cell mating feature 438 may rest on the lower plunger mating feature 310. In this regard, the plunger 300 may be lowered in the sampling shaft 604 along a direction D₁, and the containment cell 410 may follow accordingly based on the resting of the upper cell mating feature 412 on the upper plunger mating feature 306, and the respecting of the lower cell mating feature 438 on the lower plunger mating feature 310.

With reference to FIG. 7, the salt sampling system 500 is shown in a second configuration 700. In the second configuration 700, the salt sampling system 500 is lowered further into the sampling shaft 606 until the containment cell 400 contacts and rests on the lip 632. For example, the width of the containment cell 410 may be greater than the width 634 defined at the lip 632, and as such, at the lip 632 the containment cell 410 may be prevent from further descent into the sampling shaft 604.

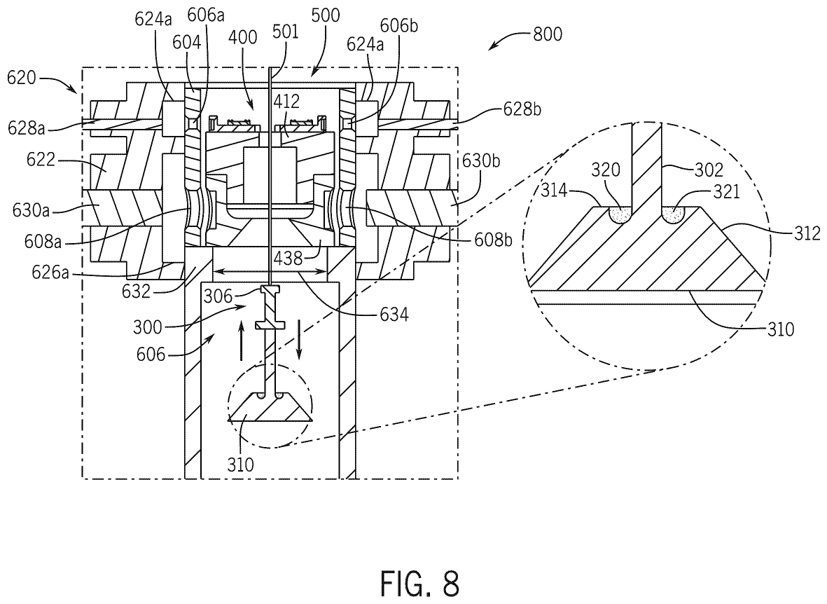

With reference to FIG. 8, the salt sampling system 500 is shown in a third configuration 800. In the third configuration 800, the containment cell 400 remains in a resting position at the lip 632 while the plunger 300 continues to advance into the molten salt material for collection of the material. For example, the plunger 300 may have a width that is generally less than the width 438 defined at the lip 632, and as such, at the lip 632 the plunger 300 may be permitted to further advance deeper in the sampling shaft 604 while the containment cell 400 remains in a resting position on the lip 632. The plunger 300 may be lowered deeper into the sampling shaft 604 and into and out of a flow of molten salt material. In this regard, the plunger 300 may receive a quantity of a molten salt material 321 within the well 320, for example, by dipping or at least partially submerging the well 320 into the flow of molten salt material. Subsequently to the collection of the molten salt material 321 within the well 320, the plunger 300 may be raised up toward the containment cell 400 for sealing of the molten salt material 321 therein.

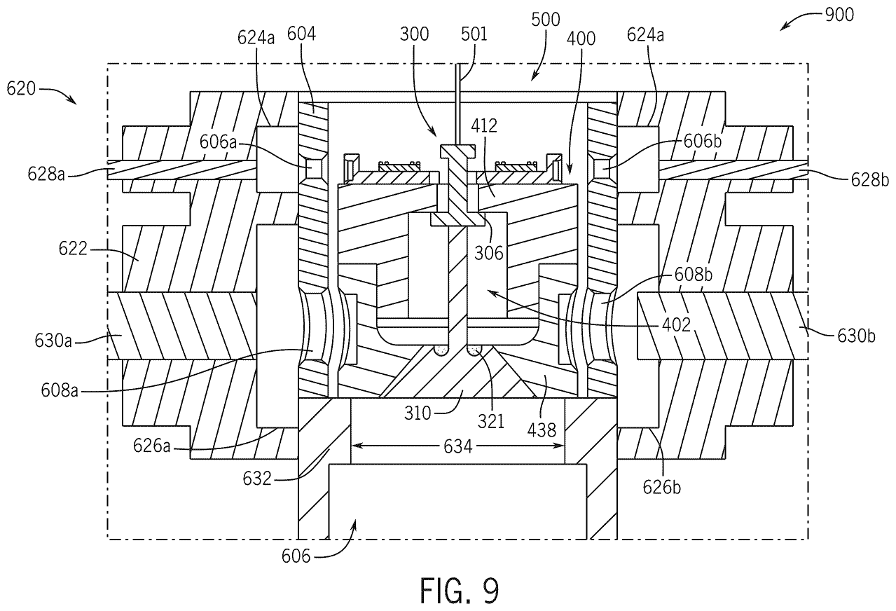

With reference to FIG. 9, the salt sampling system 500 is shown in a fourth configuration 900. In the fourth configuration 900, the plunger 300 has been returned to the containment cell 400 with the molten salt material 321 held therein. With the plunger 300 returned to the containment cell 400, the molten salt material 321 may be held within the cell volume 402.

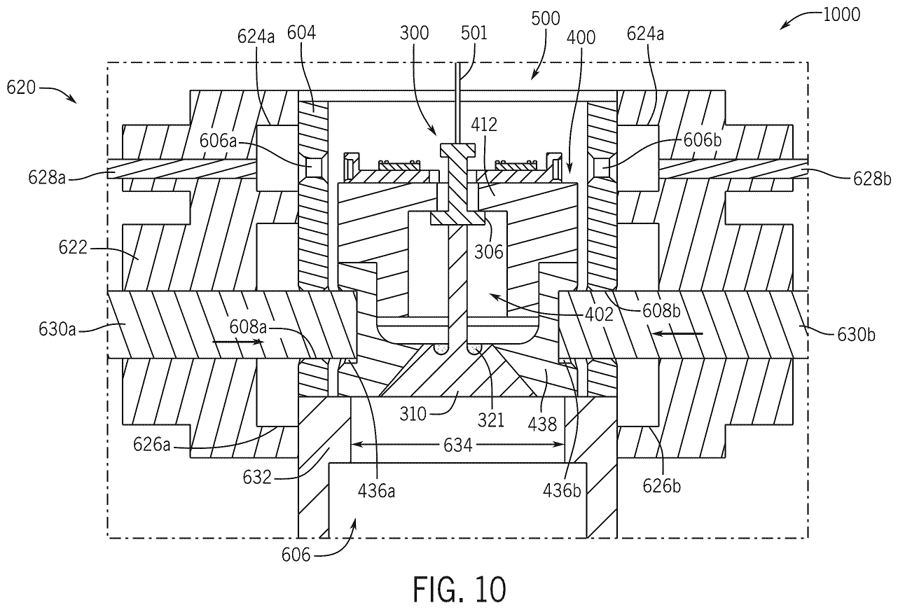

With reference to FIG. 10, the salt sampling system 500 is shown in a fifth configuration 1000. In the fifth configuration 1000, the lower pistons 630a, 630b are actuated in order to temporarily lock the containment cell 400 at the sampling station 620. For example, the lower piston 630a may be actuated and extend through the lower piston port 608a and engage with the lower piston engagement feature 436a. Further, the lower piston 630b may be actuated and extend through the lower piston port 608b and engage with the lower piston engagement feature 436b. Upon the engagement of the lower pistons 630a, 630b with corresponding ones of the lower piston engagement features 436a, 436b, the containment cell 400 may be prevented from axially movement within the sampling shaft 604.

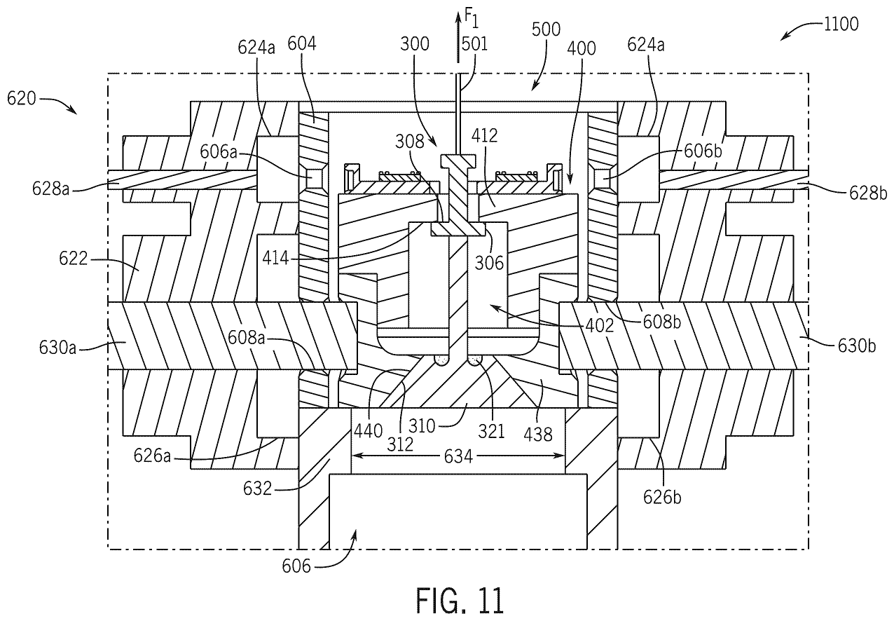

With reference to FIG. 11, the salt sampling system 500 is shown in a sixth configuration 1100. In the sixth configuration 1100, the cable 501 is actuated to exert a force F₁ on the plunger 300. The force F₁ may cause the plunger 300 and the containment cell 400 to seal the cell volume 402 about the molten salt material 321. For example, the upper cell mating surface 414 and the upper plunger mating surface 308 may contact one another to define an upper boundary of the cell volume 402 that is hermetically sealed. Further, the lower cell mating surface 440 and the lower plunger mating surface 312 may contact one another to define a lower boundary of the cell volume 402 that is hermetically sealed.

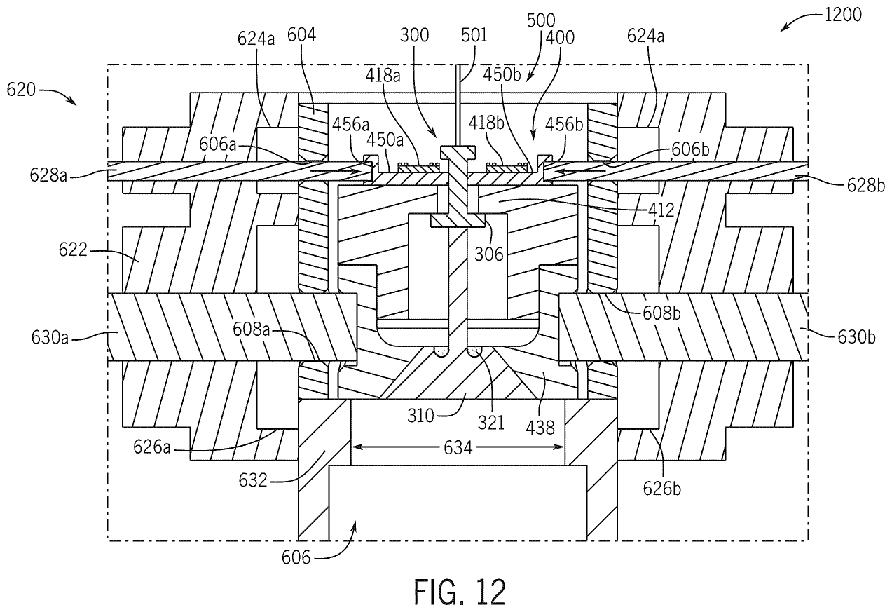

With reference to FIG. 12, the salt sampling system 500 is shown in a seventh configuration 1200. In the seventh configuration 1200, the upper pistons 628a, 628b are actuated in order to stabilize the plunger 300 within the containment cell 400 in support of the maintenance of the hermetic seals. For example, the upper piston 628a may be actuated and extend through the upper piston port 606a and engage with the upper piston engagement feature 456a of the slidable bracket 450a. Further, the upper piston 628b may be actuated and extend through the upper piston port 606b and engage with the upper piston engagement feature 456b of the slidable bracket 450b. Upon the engagement of the upper pistons 628a, 628b with upper piston engagement features 456a, 456b, the slidable brackets 450a, 450b may slide inward and engage and stabilize the plunger 300 relative to the containment cell 400.

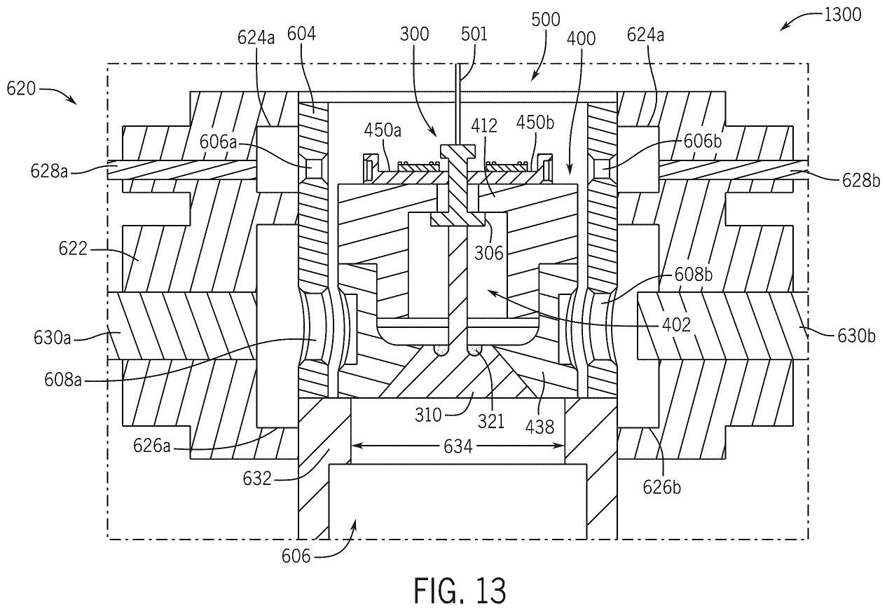

With reference to FIG. 13, the salt sampling system 500 is shown in an eighth configuration 1300. In the eighth configuration 1300, the upper pistons 628a, 628b and the lower pistons 630a, 630b are all disengaged from and released from the containment cell 400. Accordingly, the containment cell 400 may be unconstrained axially by the pistons. In this regard, the cable 501 may be actuated in order to allow the salt sampling system 500, including the containment cell 400 and the plunger 300, to be raised up into the sampling shaft 500. The sampling system 500 may be raised, via the cable 501, while the hermetic seal about the molten salt material 402 is maintained.

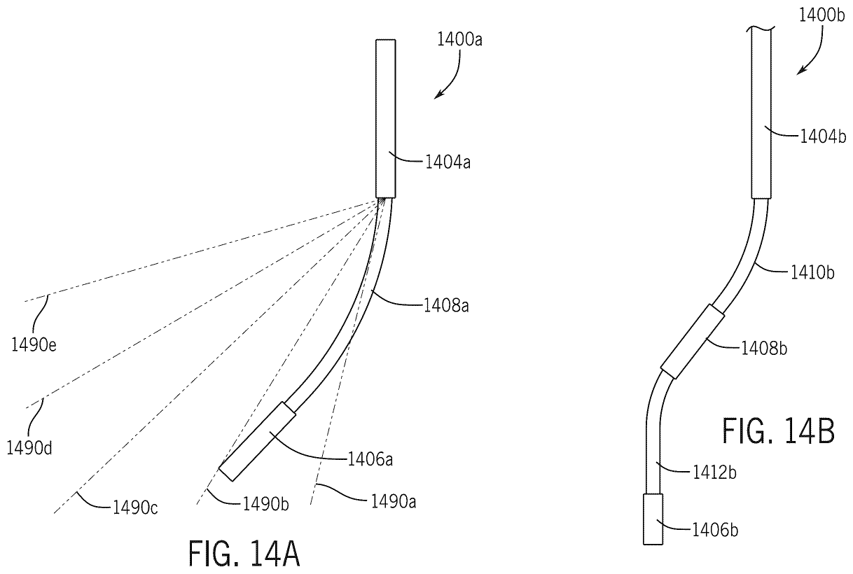

With reference to FIGS. 14A and 14B, example sampling shafts of the present disclosure are depicted. As described herein, the sampling shafts may be curved, circuitous and/or otherwise define a non-linear path. The sampling shafts may have such shape and configuration, in part, because the sampling shaft may be required to navigate tanks, vessels, valving, and/or other process equipment in order for the sampling shaft to reach the molten salt material. Accordingly, the salt sampling apparatus and systems of the present disclosure are configured to accommodate such non-linear paths of the sampling shafts and allow for the retrieval of the molten salt material. As one example, FIG. 14A shows a sampling shaft 1400a that defines a curved shaft 1408a extending between end couplings 1404a, 1406a. Based on an arrangement of the various components of the molten salt system, the end coupling 1406a may generally be positioned at any one of angular position 1490a, angular position 1490b, angular position 1490c, angular position 1490d, angular position 1490e and/or any other angular position as may be appropriate for a given application. The various salt sampling apparatus and salt sampling systems of the present disclosure may be configured to traverse the sampling shaft 1400a notwithstanding the curved profile of the curved shaft 1408a bending toward one or more of the angular positions 1490a-1490e. As another example, FIG. 14B shows a sampling shaft 1400b that defines a curved shaft 1410b and a curved shaft 1412b interposed between end couplings 1404b, 1406b and transition piece 1408b. The various salt sampling apparatus and salt sampling systems of the present disclosure may be configured to traverse the sampling shaft 1400b notwithstanding the divergent curved profiles of the curved shafts 1410b, 1412b.

FIG. 15 depicts an example salt sampling system 1500 of the present disclosure. The salt sampling system 1500 may be used with any of the salt sampling apparatuses described herein to retrieve a molten salt sample. For example, the salt sampling system 1500 may operate to selectively lower and raise one or more salt sampling apparatuses into a molten salt material, and to physical transfer and manipulate the salt sampling apparatus for retrieval by personnel. In this regard, and as shown in FIG. 15, the salt sampling system 1500 may generally include a sampling shaft 1504 having a sampling shaft volume 1505. The sampling shaft 1504 may be substantially analogous to the various sampling shafts described here, such as the sampling shaft 604, redundant explanation of which is omitted here for clarity. The sampling shaft 1504 may extend from a region of the molten salt reactor having the molten salt material to an isolation tunnel 1524. The isolation tunnel 1524 may be a pipe, tube, conduit or other structure defining an isolation tunnel volume 1525.

The isolation tunnel 1524 may permit the molten salt apparatus be transferred laterally away from the sampling shaft 1504 and fluidically isolated from the molten salt material contained therein. In this regard, the isolation tunnel 1524 is shown in FIG. 15 as including a transfer system 1514. The transfer system 1514 may include, among other components, a pulley 1516, a cable 1517, a lateral rail 1518, and a conveyor 1520. The cable 1517 and the pulley 1516 may operate to raise and lower a salt sampling apparatus (e.g., such as the example salt sampling apparatus 1590 shown in FIG. 15) from the sampling shaft 1504. For example, the pulley 1516 may be configured to rotate in a manner that lengthens and shortens the span of the cable 1517 extending therefrom, which in turn, causes a corresponding movement of the salt sampling apparatus 1590 hanging from the cable 1517. The pulley 1516 may also be coupled with the lateral rail 1518. The lateral rail 1518 may be configured to move the pulley 1516 (and associated cable 1517 and salt sampling apparatus 1590) laterally through the isolation tunnel 1524. For example, a rotational axis of the pulley 1516 may be fixed to a link, pin and/or other structure of the lateral 1518 that is configured to move laterally upon actuation of the lateral rail 1518. Accordingly, as such component of the lateral rail 1518 moves laterally, so, too, may the pulley 1516 and components associated therewith. The conveyor 1520 of the transfer system 1514 is shown arranged elevation below the lateral rial 1518. The conveyor 1520 may include a belt and/or other drive mechanism that allows for lateral movement through the isolation tunnel 1524 of objects that rest on the conveyor 1520, such as the salt sampling apparatus 1590. In this regard, and as described herein, the transfer system 1514 may be configured to release the salt sampling apparatus 1590 from the cable 1517 within the isolation tunnel 1524 such that the salt sampling apparatus 1590 rests on the conveyor 1520. The conveyor 1520 may, in turn, operate to advance the salt sampling apparatus 1590 and/or other object to an extraction position 1502. The extraction position 1502 may be a position at which the salt sampling apparatus 1590 may be physically removed from the isolation tunnel 1524.

As shown in FIG. 15, the salt sampling apparatus 1590 may be removed from the isolation tunnel 1524 by an extraction system 1554 via an extraction shaft 1544. For example, the extraction shaft 1544 may extend from and be fluidically coupled with the isolation tunnel 1524. In this regard, the extraction shaft 1544 may define an extraction shaft volume 1545 that extends from the isolation tunnel volume 1525. Further, the extraction shaft 1544 may be arranged to extend over and from the extraction position 1502 such that the salt sampling apparatus 1590 may be physically moved from the extraction position 1502 and into the extraction shaft 1544. The extraction system 1554 may operate to extract the salt sampling apparatus 1590 from the extraction position 1502. To facilitate the foregoing, the extraction system 1554 may include an extraction pulley 1556, a cable 1557, and a coupling 1558. Broadly, and as described herein, the extraction pulley 1556 may operate to raise and lower the cable 1557, including the coupling 1558, to the extraction position 1502. The coupling 1558 may engage the salt sampling apparatus 1590 at the extraction position 1502 and, upon counter rotation of the extraction pulley 1556, may cause the coupled salt sampling apparatus 1590 to travel up and into the extraction shaft 1544 for extraction from the system 1500 by personnel for chemical analysis of the molten salt contained therein.

As further shown in FIG. 15, the sampling shaft 1504, the isolation tunnel 1524, and the extraction shaft 1544 are fluidically coupled to one another in series. Further, the sample shaft 1504, the isolation tunnel 1524, and the extraction shaft 1544 are each isolatable from one another using a pair of isolation valves 1560a, 1560b. As described herein, the isolation valves 1560a, 1560b and/or other valves may be selectively closeable in order to fluidically isolate segments of the system from one another and to maintain a physical barrier (or multiple physical barriers) at all times between the molten salt material flow of the reactor and an external environment.

In operation, FIG. 15 shows the salt sampling apparatus 1590 being raised from the sampling shaft 1504. The salt sampling apparatus 1590 may be raised from a position deep in the sampling shaft 1504 whereat the salt sampling apparatus 1590 may be operable to retrieve a molten salt sample, according to the techniques described herein in relation to FIGS. 6-13. In some cases, as shown in FIG. 15, the pulley 1516 may operate to raise the salt sampling apparatus 1590 through an open configuration isolation valve 1560a. The pulley 1516 may raise the salt sampling apparatus 1590 until the salt sampling apparatus 1590 is fully within the isolation tunnel 1524 and through the isolation valve 1560a.

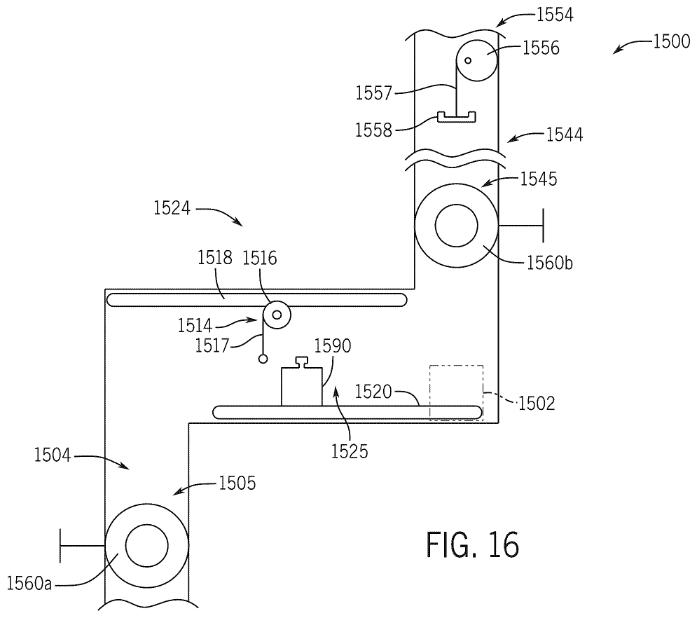

Upon the salt sampling apparatus 1590 reaching the isolation tunnel 1524, the isolation valve 1560a may close, and transfer system 1514 may operate to laterally transfer the salt sampling apparatus 1590 therethrough, as shown in FIG. 16. For example, upon reaching the isolation tunnel 1524, the lateral rail 1528 may move the pulley 1514 (and associated cable 1517 and salt sampling apparatus 1590) through the isolation tunnel 1524. The lateral rail 1528 may conduct such movement until the salt sampling apparatus 1504 is positioned over the conveyor 1520. Subsequently, the pulley 1514 may operate to lower the salt sampling apparatus 1590 on to the conveyor 1520, at which point the cable 1517 may be released from the salt sampling apparatus 1590. In turn, the conveyor 1520 may operate to move the salt sampling apparatus 1590 laterally through the isolation tunnel 1524 and to the extraction position 1502.

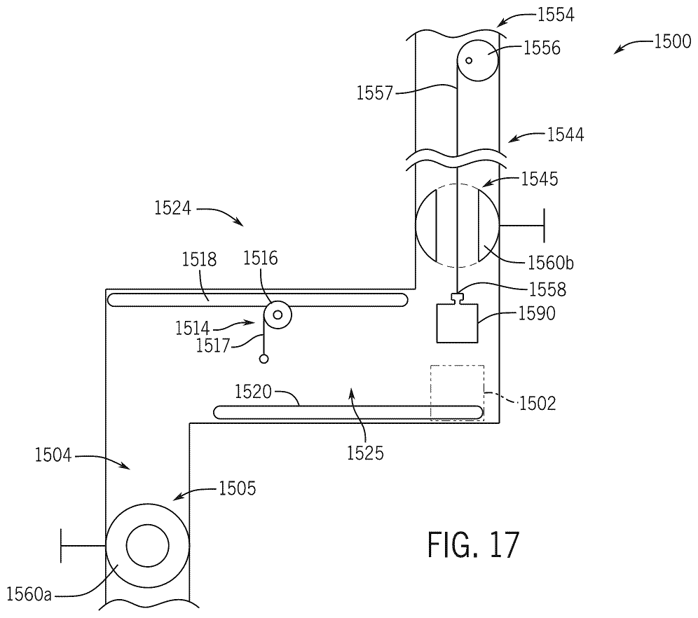

Once arranged at the extraction position 1502, the extraction system 1554 may operate to extract the salt sampling apparatus 1590 from the isolation tunnel 1524 and move the salt sampling apparatus 1590 into the extraction shaft 1544, as shown in FIG. 17. For example, the coupling 1558 may be lowered to the extraction position 1502 at which the coupling 1558 may be attached to the salt apparatus 1590. Subsequently, the extraction pulley 1556 may operate to raise the coupling 1558 (and attached salt sampling apparatus 1590) up from the extraction position 1502, through the isolation valve 1560b, and fully into the extraction shaft 1544. Upon passing the salt sampling apparatus 1590 fully through the isolation valve 1560b, the isolation valve 1560b may be closed to fluidically isolate the isolation tunnel 1524 from the extraction shaft 1544. In some cases, the salt sampling apparatus 1590 may be raised and/or further manipulated to position at which personnel may remove the salt sampling apparatus 1590 from the system for chemical analysis of the molten salt material contained therein.

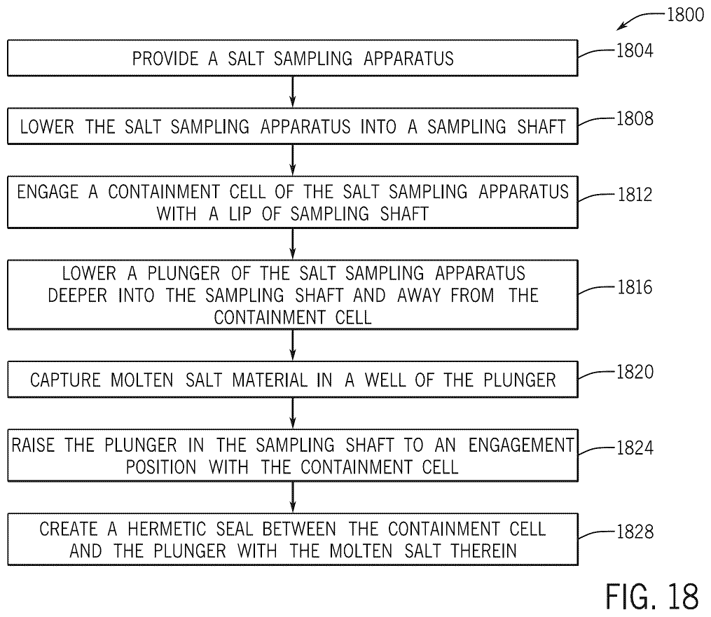

FIG. 18 depicts a flow diagram of an example method 1800 of salt sampling. For example, at operation 1804, a salt sampling apparatus is provided. For example, and with reference to FIGS. 5A-6, the salt sampling apparatus 500 may be provided. The salt sampling apparatus 500 includes the containment cell 400 and the plunger 300 associated therewith. At operation 1808, the salt sampling apparatus is lowered into a sampling shaft. For example, and with reference to FIG. 6, the salt sampling apparatus 500 may be lowered into the sampling shaft 604. The salt sampling apparatus 500 may be coupled with a cable 501 that is attached to the plunger 300 and configured to move the plunger 300 up and down within the sampling shaft 604. The containment cell 400 may rest on the plunger 300 such that movement of the plunger may cause a corresponding movement of the containment cell 400 within the sampling shaft 604.

At operation 1812, a containment cell of the salt sampling apparatus is engaged with a lip of a sampling shaft. For example, and with reference to FIG. 7, the salt sampling apparatus 500 is lowered in the sampling shaft 604 until the containment cell 400 engages the lip 632. The lip 632 may define a width 634 that is generally less than a width of the containment cell 400. Accordingly, the lip 632 may prevent the containment cell 400 from progressing deeper into the sampling shaft 604. At operation 1816, a plunger of the salt sampling apparatus is lowered deeper into the sampling shaft and away from the containment cell. For example, and with reference to FIG. 8, with the containment cell 400 resting on the lip 632, the plunger 300 may be lowered deeper into the sampling shaft 604. The cable 501 may permit the further downward movement of the plunger 300 away from the containment cell 400 and toward a molten salt material or flow at a position deeper in the reactor system. In this regard, at operation 1820, molten salt material is captured in a well of a plunger. For example, and with continued reference to FIG. 8, the plunger 300 may be lowered until some or all of the well 320 of the plunger 300 is submerged in and filled with a molten salt material 321.

At operation 1824, the plunger is raised in the sampling shaft to an engagement position within the containment cell. For example, and with reference to FIG. 9, the cable 501 may operate to raise the plunger 300 back to the containment cell 400. The cable 501 may be raise the plunger 300 to an engagement position with the containment cell 400 whereat the upper plunger mating feature 306 is engaged with the upper cell mating feature 412, and whereat the lower plunger mating feature 310 is engaged with the lower cell mating feature 438. At operation 1828, a hermetic seal is created between the containment cell and the plunger with the molten salt material therein. For example, and with reference to FIGS. 10 and 11, the containment cell 410 may be temporarily locked in place with the sampling shaft 604, such as via operation of one or more pistons (e.g., lower pistons 630a, 630b). Once locked, the cable 501 may be operated to exert an upward force on the plunger 300 that causes the plunger 300 and the containment cell 400 to form a hermetic seal about the molten salt material 321. For example, the upward force of the cable 501 may cause the upper plunger mating feature 306 and the upper cell mating feature 308 to form a hermetic seal. Further, the upward force of the cable 501 may cause the lower plunger mating feature 310 and the lower cell mating feature 438 to form a hermetic seal. The foregoing hermetic seals may cooperate to maintain an inert and sealed environment about the molten salt material 321 held within the cell volume 402.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A salt sampling system comprising
a sampling shaft, an isolation tunnel, and an extraction shaft, wherein the sampling shaft, the isolation tunnel and the extraction shaft are fluidly coupled to one another in series and isolatable from one another using a pair of isolation valves interposed therebetween,
a transfer system arranged in the isolation tunnel and configured to move a salt sampling apparatus from the sampling shaft to an extraction position of the isolation tunnel, and
an extraction system operatively engaged with the extraction shaft and configured to move the salt sampling apparatus from the extraction position to the extraction shaft.

2. The salt sampling system of claim 1, wherein the transfer system comprises
a sample pulley having a cable removably attached to the salt sampling apparatus, the sample pulley operable to move the salt sampling apparatus along and out of the sampling shaft,
a lateral rail in the isolation tunnel and coupled to the sample pulley and configured to move the sample pulley and salt sampling apparatus attached thereto laterally along the isolation tunnel, and
a conveyor in the isolation tunnel opposite the lateral rail, the conveyor configured to receive the salt sampling apparatus and convey the salt sampling apparatus along the isolation tunnel to the extraction position,
wherein the salt sampling apparatus is removably couplable from the cable.

3. The salt sampling system of claim 1, wherein the extraction system comprises an extraction pulley having a cable removably attachable to the salt sampling apparatus, the extraction pulley operable to move the salt sampling apparatus from the extraction position and into the extraction shaft.

4. The salt sampling system of claim 1, wherein
the pair of isolation valves comprises a first isolation valve arranged between the sampling shaft and the isolation tunnel, and a second isolation valve arranged between the isolation tunnel and the extraction shaft,
the salt sampling system is operable to maintain isolation of the sampling shaft and the extraction shaft
in a first configuration, with the first isolation valve open and the second isolation valve closed, thereby permitting the movement of the salt sampling apparatus from the sampling shaft, through the first isolation valve, and into the isolation tunnel,
in a second configuration, with the first and second isolation valves closed, thereby permitting the movement of the salt sampling apparatus through the isolation tunnel and to the extraction position,
in a third configuration, with the first isolation valve closed and the second isolation valve open, thereby permitting the movement of the salt sampling apparatus from the extraction position, through the second isolation valve, to the extraction shaft, and
in a fourth configuration with the first and second isolation valves closed, thereby permitting movement of the salt sampling apparatus along and out of the extraction shaft.

5. The salt sampling system of claim 1, wherein the salt sampling apparatus comprises
a containment cell defining
a cell volume,
an upper cell mating feature and a lower cell mating feature within the cell volume, and
a through-bore extending completely through the containment cell and intersecting the cell volume; and
a plunger arrangeable within the cell volume along the through-bore and defining
a shaft portion, and
an upper plunger mating feature and a lower plunger mating feature, wherein each of the upper plunger mating feature and the lower plunger mating feature extend laterally from the shaft portion and are axially off set from one another along the shaft portion,
wherein the lower plunger mating feature defines a well about the shaft portion configured to receive a volume of a molten salt material, and
wherein the plunger is moveable between
a first position in which the well is positioned substantially out of the cell volume, and
a second position in which the well is positioned substantially in the cell volume with the upper plunger feature and the lower plunger feature contacting a respective one of the upper cell mating feature and the lower cell mating features to seal a received volume of molten salt material within the cell volume.

6. A salt sampling apparatus comprising
a containment cell defining
a cell volume,
an upper cell mating feature and a lower cell mating feature within the cell volume, and
a through-bore extending completely through the containment cell and intersecting the cell volume; and
a plunger arrangeable within the cell volume along the through-bore and defining
a shaft portion, and
an upper plunger mating feature and a lower plunger mating feature, wherein each of the upper plunger mating feature and the lower plunger mating feature extend laterally from the shaft portion and are axially off set from one another along the shaft portion,
wherein the lower plunger mating feature defines a well about the shaft portion configured to receive a volume of a molten salt material, and
wherein the plunger is moveable between
a first position in which the well is positioned substantially out of the cell volume, and
a second position in which the well is positioned substantially in the cell volume with the upper plunger feature and the lower plunger feature contacting a respective one of the upper cell mating feature and the lower cell mating feature to seal a received volume of molten salt material within the cell volume.

7. The salt sampling apparatus of claim 6, wherein, in the second position, the received volume of molten salt is hermetically sealed within the cell volume.

8. The salt sampling apparatus of claim 6, wherein
the through-bore is defined along an axial direction of the containment cell,
the upper cell mating feature and the lower cell mating feature are defined about the through-bore, and
the upper plunger mating feature and the lower plunger mating feature are defined about the shaft portion.

9. The salt sampling apparatus of claim 8, wherein the plunger is moveable between the first position and the second position along the axial direction.

10. The salt sampling apparatus of claim 8, wherein, in the second position,
the upper cell mating feature and the upper plunger mating feature cooperate to form an upper hermetic seal of the cell volume fully about the shaft portion, and
the lower cell mating feature and the lower plunger mating feature cooperate to form a lower hermetic seal of the cell volume fully about the shaft portion.

11. The salt sampling apparatus of claim 6, wherein
the lower plunger mating feature defines a lower plunger mating surface that extends angularly relative to the shaft portion, and
the lower cell mating feature defines a lower cell mating surface that is complementary to the lower plunger mating surface.

12. The salt sampling apparatus of claim 6, wherein the containment cell stops relative axial movement of the plunger at the second position by
an engagement of the upper cell mating feature and the upper plunger mating feature, and
an engagement of the lower cell mating feature and the lower plunger mating feature.

13. The salt sampling apparatus of claim 6, wherein the well defines a sample volume for the molten salt material fully about the shaft portion.

14. The salt sampling apparatus of claim 6, wherein the containment cell comprises
a housing,
a receptacle piece engaged with the housing, the receptacle piece and the housing cooperating to define the cell volume and the through-bore extending therethrough, and
a pair of slidable brackets engaged with a top surface of the housing on opposing sides of the through-portion, the pair of slidable brackets slidable between
an open position in which the through-bore is substantially unobstructed by the pair of brackets, and
a locking position in which the through-bore is at least partially obstructed by the pair of brackets.

15. The salt sampling apparatus of claim 14, wherein
the housing and/or receptacle piece defines a pair of lower piston engagement features configured to receive a corresponding pair of lower pistons for locking the containment cell axially, and
the pair of slidable brackets define a respective pair of upper piston engagement features configured to receive a corresponding pair of upper pistons for sliding the brackets between the open position and the closed locking position while the containment cell is locked axially.

16. The salt sampling apparatus of claim 6, wherein the plunger comprises an attachment mechanism extending from the shaft portion opposite the lower plunger mating feature, the attachment mechanism configured to couple the plunger to a cable of a pulley.

17. A method of salt sampling comprising
providing the salt sampling apparatus of claim 6;
lowering the salt sampling apparatus into a sampling shaft;
engaging the containment cell on a lip within the sampling shaft;
lowering the plunger deeper into the sampling shaft to the first position while the containment cell rests on the lip; and
capturing molten salt material in the well.

18. The method of claim 17, further comprising raising the plunger in the sampling shaft from the first position to the second position.

19. The method of claim 18, further comprising creating a hermetic seal between the upper cell mating feature and the upper plunger mating feature and the lower cell mating feature and the lower plunger mating feature by
locking the containment cell axially along the sampling shaft using one or more pistons, and
inducing a force on the plunger that biases and compresses the plunger toward the containment cell.

20. The method of claim 19, wherein
the one or more pistons comprises a pair of lower pistons,
the method further comprises
operating a pair of upper pistons to slide a corresponding pair of slidable brackets of the containment cell toward the plunger to stabilize a lateral position of the plunger within the containment cell,
releasing the pair of lower pistons and the pair of upper pistons from the containment cell, and
moving salt sampling apparatus out of the sampling shaft for retrieval of the molten salt collected therein.
